(19) United States
(12) Patent Application Publication
(10) Pub. No.: US 2008/0229153 A1
(43) Pub. Date: Sep. 18, 2008

(54) System and method of network error analysis

(75) Inventors: Zhi Li, San Ramon, CA (US); Raghvendra Savoor, Walnut Creek, CA (US)

Correspondence Address: TOLER LAW GROUP, 8500 BLUFFSTONE COVE, SUITE A201, AUSTIN, TX, 78759, US

(73) Assignee: AT&T Knowledge Ventures, LP, Reno, NV (US)

(21) Appl. No.: 11/717,574

(22) Filed: Mar. 13, 2007

(51) Int. Cl. G06F 11/00

(52) U.S. Cl. 714/39

(57) ABSTRACT

Systems and methods for network analysis are provided. A system may include an input to receive communication reports from a plurality of end terminals of a multicast network. The system may also include a memory including multicast network topology data. The system may also include logic to determine a source of at least one communication anomaly based on received communication reports and the multicast network topology data.

### FIELD OF THE DISCLOSURE

The present disclosure is generally related to computer networks and to computer network error analysis.

### BACKGROUND

Multicasting is a technique for communicating data. Generally, a source device of a multicasting network sends one copy of each data packet, even if the data packet is to be delivered to a large number of receivers. The data packet is propagated throughout the network, as each of the nodes in the multicast network replicates the data packet and sends a copy to each receiver that it serves.

Problems in multicast networks may be difficult to troubleshoot due to the complexity of these networks. Hence there is a need for an improved system and method of network error analysis in multicast networks.

### BRIEF DESCRIPTION OF THE DRAWINGS

FIG. 1 is a block diagram of a first particular embodiment of a system to analyze network errors;

FIG. 2 is a block diagram of a second particular embodiment of a system to analyze network errors;

FIG. 3 is a flow chart of a first particular embodiment of a method of network error analysis;

FIG. 4 is a flow chart of a second particular embodiment of a method of network error analysis;

FIG. 5 is a flow chart of a third particular embodiment of a method of network error analysis; and

FIG. 6 is a block diagram of an illustrative embodiment of a computer system.

### DETAILED DESCRIPTION OF THE DRAWINGS

In a particular embodiment, a system for network error analysis may include an input to receive communication reports from a plurality of end terminals of a multicast network. The system may also include a memory including multicast network topology data. The system may also include logic to determine a source of at least one communication anomaly based on received communication reports and the multicast network topology data.

In a particular embodiment, a method of network error analysis may include receiving a first communication report from a first end terminal of a multicast network. The first communication report may identify a communication anomaly that occurred at the first end terminal and first operational history data regarding the first end terminal. The method may also include receiving a second communication report from a second end terminal of the multicast network. The second communication report may identify second operational history data regarding the second end terminal. The method may also include determining a potential cause of the communication anomaly based at least partially on the first operational history data, the second history operational data, and topology data related to the multicast network.

In a particular embodiment, a computer readable medium may include computer readable instructions executable by a computer to perform a method including receiving a plurality of communication reports from end terminals of a multicast network. The method may also include determining a potential cause of at least one communication anomaly based at least partially on one or more of the plurality of communication reports and network topology information.

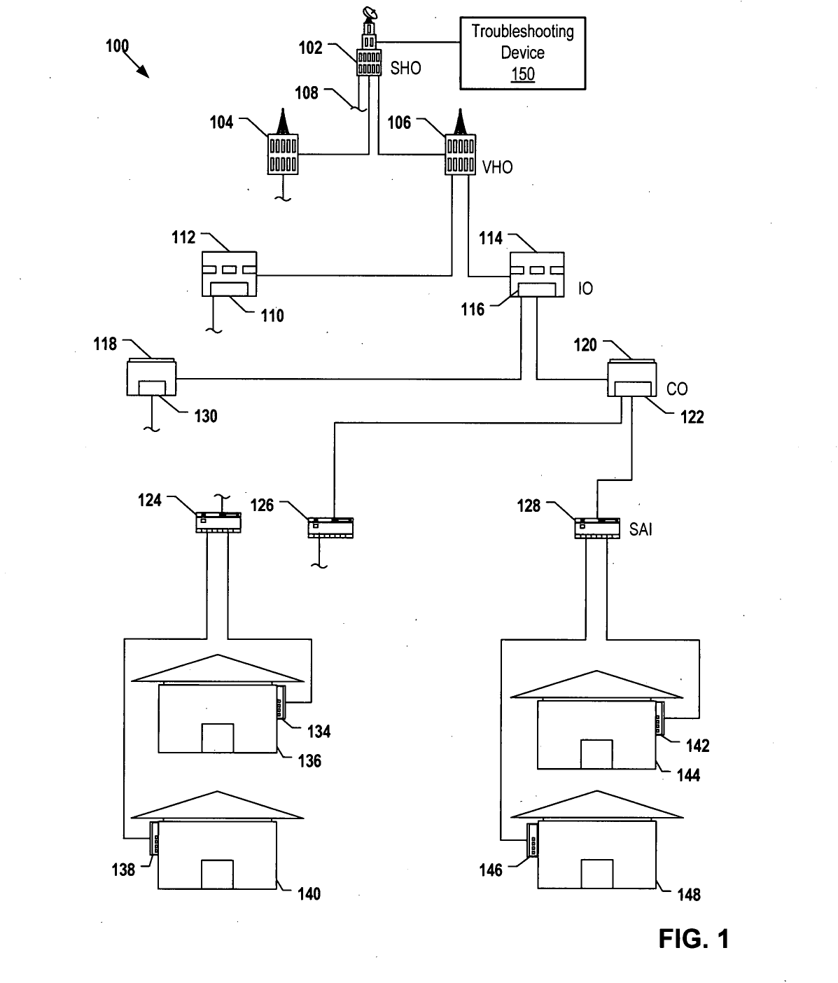

FIG. 1 is a block diagram of a first particular embodiment of a system to analyze network errors, generally designated 100. The system 100 may include elements of a multicast network. In a particular illustrative embodiment, the system 100 may include elements of a multicast video distribution network, such as an Internet Protocol Television (IPTV) network.

The system 100 includes a super headend office (SHO) 102 communicating with one or more video hub offices (VHO) 104, 106. The VHOs 104, 106 may communicate with customer premises equipment (CPE) devices 134, 138, 142, 146 via service area interfaces (SAIs) 124, 126, 128. In a particular embodiment, the VHOs 104, 106 may communicate with the SAIs 124, 126, 128 via one or more intermediate offices (IO) 112, 114, one or more central offices (CO) 118, 120, or any combination thereof.

In a particular embodiment, the various offices in the system 100, such as the SHO 102, the VHO 104, 106, the IO 112, 114, and the CO 118, 120, may each service a particular geographic area or market. For example, the SHO 102 may be a national SHO from which content is distributed nationally via the system 100. The SHO 102 may send data via a network to VHOs 104, 106. While only two VHOs are depicted in FIG. 1, the system 100 may include any number of VHOs as indicated by the network continuation mark 108.

In a particular embodiment, local content associated with the market area served by each VHO 104, 106 may be gathered at the VHO for distribution via the system 100. For example, the VHO 106 may serve a large metropolitan area, and content specific to that metropolitan area, such as local television content, advertising, other content, or any combination thereof may be distributed via the system 100 from the VHO 106. The VHO 106 may also distribute the content received from the SHO 102 to the market area served by the VHO 106. The VHO 104 may also distribute the content received from the SHO 102 and local content to the market area served by the VHO 104.

In a particular embodiment, each VHO 104, 106 may send data via the system 100 to one or more IOs 112, 114. In a particular embodiment, the representative IO 114 includes a service router (SR) 116, such as the Alcatel™ 7750 service router available from Alcatel-Lucent of Paris, France. The SR 116 may generate and maintain a multicast routing tree associated with portions of the system 100 including (without limitation) portions downstream with respect to the IO 114. For example, the multicast routing tree maintained by the SR 116 may pertain to portions of the system served via the SR 116, such as CO 118 and CO 120. The representative IO 112 may also include a SR 110 that generates and maintains a multicast routing tree associated with portions of the system 100 downstream of the IO 112. In a particular illustrative embodiment, the SR 116 may receive data sent from the SHO 102 and VHO 106 addressed to a multicast group. The SR 116 may also maintain a list of CPE devices joined to the multicast group. The SR 116 may send data addressed to the multicast group to the members of the multicast group (i.e., CPE devices joined to the multicast group) according to the multicast routing tree.

In FIG. 1, data sent via the representative IO 114 may be received at the representative COs 118, 120. The COs 118, 120 may each include an Ethernet service switch (ESS) 130, 122, such as the Alcatel™ 7450 Ethernet Service Switch available from Alcatel-Lucent of Paris, France. The ESS 130, 122 may send the data based on the multicast routing tree to devices served by the COs 118, 120. For example, the representative ESS 122 may send data addressed to a first multicast group to the representative SAI 128, if a CPE device served by the SAI 128 is joined to the first multicast group.

In a particular embodiment, the ESSs 130, 122 may send data to a plurality of service area interfaces (SAIs) 124, 126, 128. In a illustrative embodiment, the SAIs 124, 126, 128 may include fiber-to-user nodes, such as the Alcatel™ 7340 Fiber to the User (FTTU), or twisted pair nodes, such as the Alcatel™ 7330 Intelligent Service Access Manager (ISAM) Fiber to the Node (FTTN), both available from Alcatel-Lucent of Paris, France, or other interfaces to terminate a communication medium coupled to CPE devices 134, 138, 142, 146. For example, the SAIs 124, 126, 128 may communicate with the CPE devices 134, 138, 142, 146 via fiber optic spans, twisted wire pairs, such as digital subscriber line (DSL) loops, wireless transmissions, other communication media, or any combination thereof. The CPE devices 134, 138, 142, 146 may include set-top box devices, routers, local area network devices, modems, such as digital subscriber line (DSL) modems, any other suitable devices for facilitating communication with the multicast network, or any combination thereof.

For ease of reference, a set of network nodes (e.g., routers, switches, interfaces, servers, etc.) and communication media used to send data to an end terminal may be referred to as a communication path to the end terminal. For example, the communication path to CPE device 142 may include the SAI 128, the communication medium between the CPE device 142 and the SAI 128, the ESS 122, the communication medium between the SAI 128 and the ESS 122, the SR 116, the communication medium between the ESS 122 and the SR 116, and so forth. Additionally, for ease of reference a network node at which the communication path to a first end terminal diverges from the communication path to a second end terminal may be referred to as a split between the communication paths. For example, the SAI 128 is the last network node common to the communication path to the CPE device 142 and the CPE device 146. Thus, the SAI 128 is the node at which the communication paths diverge, and SAI 128 is where the split between the communication paths occurs.

In a particular embodiment, the system 100 may function as a multicast video distribution network in which each video channel is distributed via a particular multicast group. Thus, using customer residence 144 as an example, when a customer at the customer residence 144 desires to view a particular channel, the customer may interact with the CPE device 142 to join the multicast group associated with the particular channel. The CPE device 142 may send a message to the SR 116 via the system 100 to join the particular multicast group associated with the channel. In an illustrative non-limiting embodiment, the message can be an Internet Group Management Protocol (IGMP) join message. The SR 116 may add the CPE device 142 to the multicast routing tree for the particular multicast group. Content data addressed to the particular multicast group may be routed to the CPE device 142 based on the multicast routing tree, and the customer may be provided a display including the content of the channel associated with the multicast group.

In a particular embodiment, the representative SR 116 receives a single copy of data to be multicast. For example, considering a single data packet of a data stream for a particular channel, the data packet may be sent from the VHO 106 to the IO 114 addressed to a multicast group associated with the particular channel. The SR 116 associated with the IO 114 may receive the data packet and access a multicast routing tree associated with the multicast group to which the data packet is addressed to determine further routing of the data packet. The multicast routing tree may indicate which end terminals, e.g., CPE devices, are joined to the multicast group. The SR 116, or other device at the IO 114, may replicate the data packet and send copies of the data packet to COs that serve end terminals joined to the multicast group. For example, the SR 116 may replicate the data packet and send copies of the data packet to representative COs 118, 120.

One or more ESSs at each of the COs 118, 120 may receive a copy of the replicated the data packet. For example, the representative ESS 122 may receive a copy of the data packet replicated by the SR 116 and determine based on the multicast routing tree where to send the copy. For illustration, if the SAI 126 and the SAI 128 each serve CPE devices that are joined to the multicast group, the ESS 122 may replicate the data packet and send copies of the copy of the data packet to the SAIs 126, 128.

The SAIs 126, 128 may each receive a copy of the data packet and, based on the multicast routing tree, may send copies of the data packet to CPE devices that are joined to the multicast group. Taking the SAIs 124 and 128 as examples, the SAI 124 may send copies of the data packet to the CPE devices 134 and 138, assuming both of these CPE devices are joined to the multicast group. Similarly, the SAI 128 may send copies of the data packet to CPE devices 142 and 146 if both of these CPE devices are joined to the multicast group.

In a particular embodiment, each end terminal of the system 100, for example, each CPE device 134, 138, 142, 146 may maintain a record of communication anomalies that occur at the end terminal. In an illustrative embodiment, a communication anomaly may include one or more data packets that were expected but not received, one or more unreadable data packets, an inability to join a multicast group, another communication error, or any combination thereof. In a particular illustrative embodiment, if one or more data packets expected at the representative CPE device 134 are not received, the CPE device 134 may make an entry in a performance log indicating that the one or more data packets were not received. The end terminal may also track operational history data associated with the end terminal. For example, the representative CPE device 134 may track operational history data such as the particular multicast group to which the CPE device 134 was joined at a particular times (e.g., when the communications anomaly occurred), other status information related to the CPE device 134, or any combination thereof.

In a particular embodiment, the system 100 may include a troubleshooting device 150. The troubleshooting device 150 may receive communication reports from end terminals of the system 100, such as the CPE devices 134, 138, 142, 146. The communication reports may identify communication anomalies that occurred at each end terminal. The communication reports may also include operational history data associated with the end terminals. The troubleshooting device 150 may analyze the communication reports to determining a potential cause of a communication anomaly based on the operational history data and topology data related to the system 100.

In a particular embodiment, the troubleshooting device 150 may receive a first communication report from a first end terminal. The first communication report may identify a communication anomaly that occurred at the first end terminal. The first communication report may also include operational history data associated with the first end terminal. The troubleshooting device 150 may also receive a second communication report from a second end terminal. The second communication report may include operational history data associated with the second end terminal. The troubleshooting device 150 may determine the potential cause of the communication anomaly based on the first and second communication reports and network topology information related to the system 100. The troubleshooting device 150 may also query a third end terminal for a third communication report. The third communication report may include operational history data associated with the third end terminal. The troubleshooting device may determine a probably cause of the communication anomaly based on the first communication report, the second communication report, the third communication report, and the network topology information.

In an illustrative embodiment, the troubleshooting device 150 may receive a communication report from the CPE device 146 indicating that a communication error has occurred at the CPE device 146. The troubleshooting device 150 may query one or more other CPE devices, such as the CPE device 134, the CPE device 138 or the CPE device 142, for communication reports from these devices. The communication reports may indicate whether the communication error also occurred at one or more of those CPE devices. Additionally the communication report may include operational history data associated with the customer premises equipment 146 and operational history data associated with the one or more queried CPE devices. Using the communication reports received from the CPE device 146 and the one or more queried CPE devices, the troubleshooting device 150 may determine a potential cause of the communication anomaly.

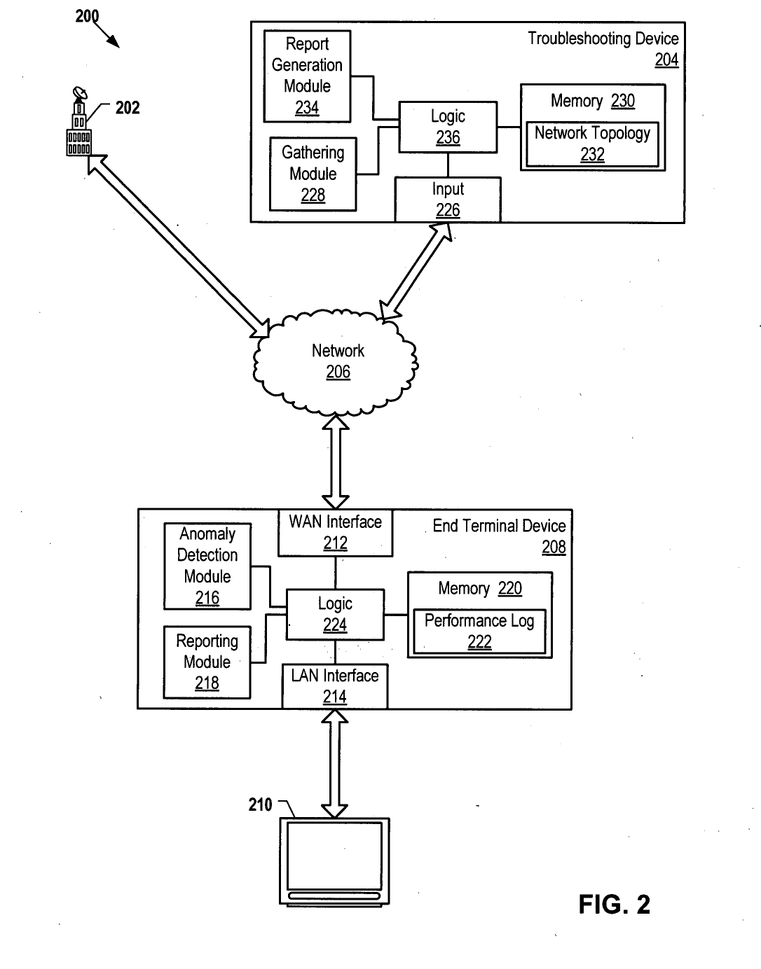

FIG. 2 is a block diagram of a second particular embodiment of a system to analyze network errors, generally designated 200. The system 200 includes a SHO 202, a troubleshooting device 204, and an end terminal device 208. The SHO 202 communicates with the end terminal device 208 via a multicast network 206. For example, the SHO 202 may transmit video data to the end terminal device 208 via the multicast network 206. In a particular embodiment, the troubleshooting device 204 communicates with the end terminal device 208 via the multicast network 206.

In a particular embodiment, the end terminal device 208 may be a CPE device, such as the CPE devices 134, 138, 142, 146 depicted in FIG. 1. The end terminal device 208 may include a wide area network (WAN) interface 212 to communicate with the network 206. The end terminal device 208 may also include a local area network (LAN) interface 214 to communicate with one or more customer devices, such as a display device 210.

In a particular embodiment, the end terminal device 208 may include an anomaly detection module 216. The anomaly detection module 216 may monitor data received via the network 206 to determine whether a communication anomaly has occurred. If a communication anomaly is detected, the anomaly detection module 216 may generate a performance log entry and store the performance log entry in a performance log 222 stored at memory 220. In an illustrative embodiment, the performance log 222 may include data identifying communication anomalies and operational history data associated with each communication anomaly. In a particular illustrative embodiment, the performance log 222 may also include operational history data that is not correlated with a communication anomaly, such as a multicast group to which the end terminal device 208 was joined at a particular time.

In a particular embodiment, the end terminal device 208 may also include a reporting module 218. The reporting module 218 may generate a communication report based on the performance log 222. The reporting module 218 may also send the communication report via the WAN interface 212 to the troubleshooting device 204.

The end terminal device 208 may also include logic 224. The logic 224 may invoke the anomaly detection module 216 to monitor received data for communication anomalies. The logic may also invoke the reporting module 218 to report detected communication anomalies. In an illustrative embodiment, the logic 224 may also invoke the reporting module 218 to generate and send a communication report in response to a query received from the troubleshooting device 204 or in response to the detection of a communication anomaly by the anomaly detection module 216.

In a particular embodiment, the troubleshooting device 204 may include an input 226, a gathering module 228, a report generation module 234, a memory 230, and logic 236. In a particular illustrative embodiment, the memory 230 may include network topology data 232.

In a particular embodiment, the input 226 may receive data related to communication reports from a plurality of end terminals associated with multicast network 206, such as the end terminal device 208. The logic 236 may evaluate the plurality of communication reports and the network topology data 232 to determine a source of at least one communication anomaly. For example, the end terminal device 208 may send a first communication report via the multicast network 206 to the troubleshooting device 204. The first communication report may indicate that a communication anomaly has occurred at the end terminal device 208. The first communication report may also include operational history data associated with the communication anomaly, such as the multicast group at which the anomaly occurred, the time and date of the anomaly, other operational history data, or any combination thereof. The gathering module 228 may identify one or more additional end terminal devices to query for communication reports based on the first communication report; historical information related to the end terminal device 208; historical information related to the one or more additional end terminal devices; historical information related to a subscriber associated with the end terminal device 208; network topology information; the causes of historical communication anomalies; other information related to the end terminal device 208, the additional end terminal devices; or the communication anomaly, or any combination thereof. The logic 236 may analyze the received communication reports and the network topology data 232 to determine a source of the least one communication anomaly.

The network topology data 232 may identify at least one connection between two or more network devices of the multicast network 206. For example, referring to FIG. 1, the multicast network topology data 232 may indicate a physical connection between the SR 116 at IO 114 and the ESS 122 at CO 120. In a particular illustrative embodiment, the network topology data 232 may also identify at least one connection between a device of the multicast network 232 and at least one end terminal 208. For example, referring again to FIG. 1, the network topology data 232 may indicate that the CPE device 142 has a physical connection to the SAI 128. The network topology data 232 may also include information about logical connections between devices of the multicast network 206. For example, the network topology data 232 may include a multicast routing tree. The multicast routing tree may identify end terminals joined to a particular multicast group and at least a portion of a communication path to each end terminal. In an illustrative embodiment, the network topology data 232 may be used to identify a potential source of the communication anomaly. For example, the network topology data 232 may be used in conjunction with communication reports received from end terminal devices to identify a node of the multicast network 206, that provided data to the end terminal where the communication anomaly occurred, but did not provide data to end terminals where the communication anomaly did not occur.

In a particular embodiment, the report generation module 234 may generate a report identifying the source of the communication anomaly. For example, the report generation module may generate a user interface display at a display device in communication with the troubleshooting device 204. The user interface display may identify one or more network devices responsible for the communication anomaly.

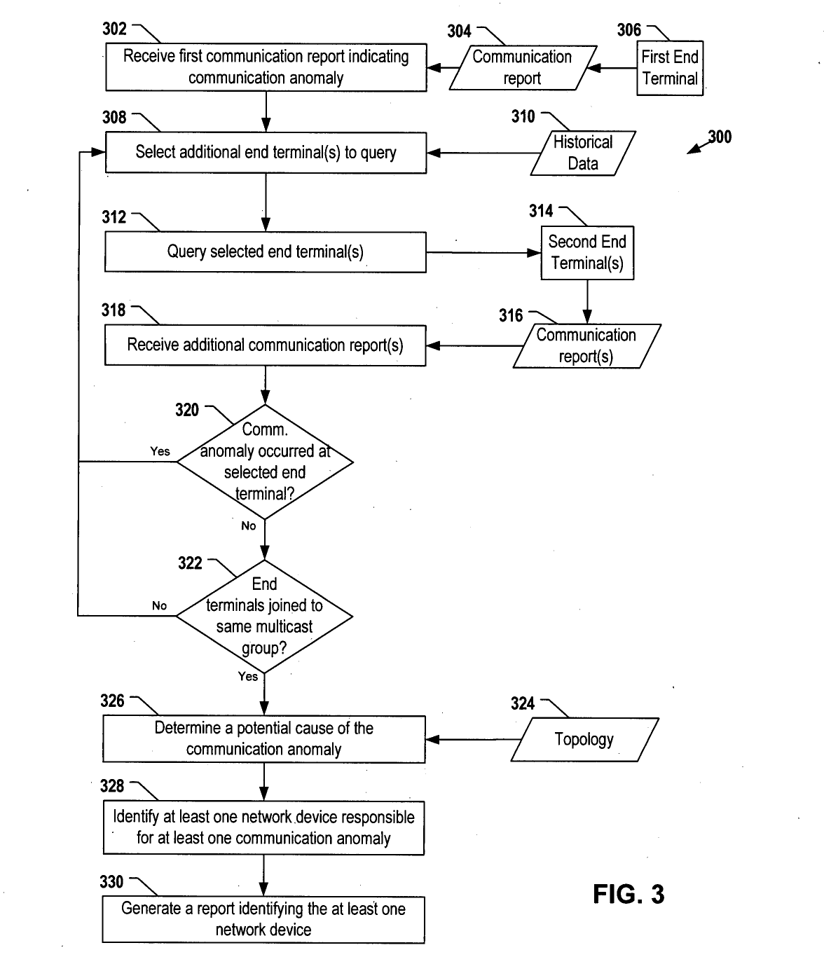

FIG. 3 is a flow chart illustrating a particular embodiment of a method of network error analysis, generally designated 300. The method 300 includes, at 302, receiving a first communication report 304 indicating that a communication anomaly occurred at a first end terminal 306 of a multicast network. The method 300 also includes, at 308, selecting one or more additional end terminals to query. The one or more additional end terminals may be selected based on historical data 310. The historical data 310 may include, for example, historical data related to the one or more additional end terminals, historical data related to the first end terminal, information related to a subscriber associated with one of the end terminals, information related to previous communication anomalies, other historical information, or any combination thereof. The one or more second end terminals 314 may also be selected based on network topology data. The method 300 may also include, at 312, sending a query to the one or more selected end terminal(s) 314.

In a particular embodiment, the method 300 may include, at 318, receiving one or more additional communication reports 316 from the selected end terminal(s) 314. In a particular embodiment, the method 300 may also include, at 320, determining whether the communication anomaly occurred at the selected end terminal 314. For example, if the additional communication report 316 indicates that the communication anomaly did not occur at the selected end terminal 314, the method 300 may determine that the potential cause of the communication anomaly is a network device that communicates with the first end terminal 306 and does not communicate with the selected end terminal 314.

In a particular illustrative embodiment, if the additional communication report 316 indicates that the communication anomaly occurred at the selected end terminal 314, the method 300 may select another end terminal, e.g., a third end terminal, at 308. The method 300 may also include receiving a third communication report from the third end terminal. The third communication report may include third operational history regarding the third terminal. The method 300 may also include determining the potential cause of the communication anomaly based at least partially on the first operational history data, the additional operational history data, the third operational history data, and the topology data related to the multicast network.

In a particular illustrative embodiment, if the additional communication report 316 indicates that the communication anomaly did not occur at the selected end terminal 314, the method may include, at 322, determining whether the selected end terminal was joined to the same multicast group as the first end terminal 306 when the communication anomaly occurred at the first end terminal 306. If the selected end terminal 314 was joined to a different multicast group than the first end terminal 306, the method 300 may select another end terminal, at 308. The method 300 may include, at 326, determining the potential cause of the communication anomaly based at least partially on the first operational history data, the additional operational history data, and the topology data.

The method 300 may also include, at 328, identifying at least one network device responsible for the communication anomaly. The method 300 may also include, at 330, generating a report identifying the at least one network device responsible for the communication anomaly.

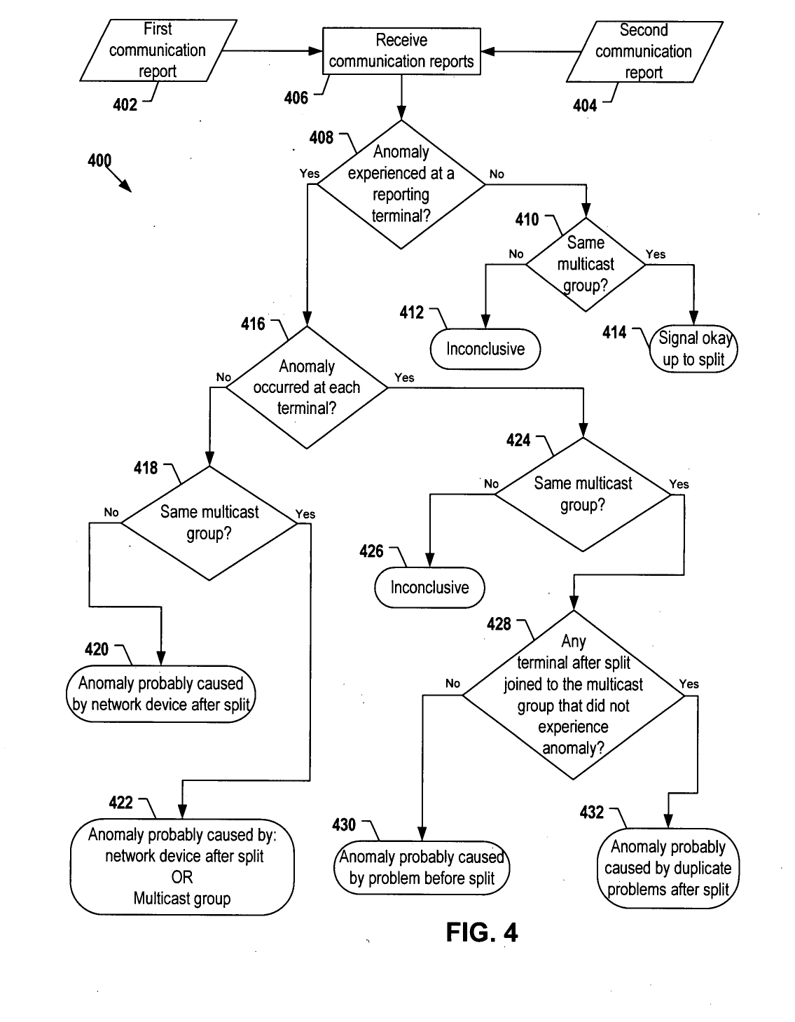

FIG. 4 is a flow chart illustrating a second particular embodiment of a method of network error analysis, generally designated 400. The method 400 includes, at 406, receiving a plurality of communication reports, such as a first communication report 402 and a second communication report 404, from a plurality of reporting end terminals. The method 400 also includes, at 408, determining whether a communication anomaly occurred at a reporting end terminal. If no communication anomaly occurred at a reporting terminal, the method 400 may include, at 410, determining whether the reporting end terminals were joined to the same multicast group when the communication anomaly occurred. If the reporting terminals were not joined to the same multicast group, an inconclusive result may be obtained, as indicated at 412. A determination that the method 400 is inconclusive may indicate that additional communication reports should be gathered to resolve the inconclusive status. Returning to 410, if the reporting terminals were joined to the same multicast group when the communication anomaly occurred, the method may conclude that communications via the multicast network are operating normally at least up to the split. Here, the “split” refers to a point at which the communication paths to two or more end terminals diverge. For example, the multicast network may route data to end terminals using a multicast routing tree. The multicast routing tree may identify network nodes that communicate with particular end terminals. The split refers to a node of the multicast tree that provides data to all of the two or more end terminals.

Returning to 408, if a communication anomaly was experienced at one of the reporting end terminals, the method 400 may include, at 416, determining whether the communication anomaly was experienced at each of the reporting end terminals. If the communication anomaly was not experienced at each of the reporting end terminals, the method 400 may include, at 418, determining whether all of the reporting end terminals were joined to the same multicast group at the time the communication anomaly occurred. If the reporting end terminals were not joined to the same multicast group at the time the communication anomaly occurred, it may be determined at 420, that the communication anomaly was probably caused by a network device after the split between the reporting end terminals. That is, at a network node that does not provide data to both the reporting end terminals where the communication anomaly occurred and the reporting end terminals where the communication anomaly did not occur. If the reporting end terminals were joined to the same multicast group when the communication anomaly occurred, it may be determined, at 422, that the communication anomaly was probably caused either by a network device after the split between the communication path to the reporting end terminals at which the communication anomaly occurred and the communication path to reporting end terminals at which the communication anomaly did not occur, or by a device associated with the multicast group, e.g., a channel router. In a particular embodiment, additional communication reports may be requested from other end terminals of the multicast network to determine whether the communication anomaly was caused by a network device after the split, or by a device associated with the multicast group.

Returning to 416, if the communication anomaly was experienced at each reporting end terminal, the method 400 may include, at 424, determining whether the reporting end terminals were joined to the same multicast group when the communication anomaly occurred. If the reporting end terminals were not joined to the same multicast group, an inconclusive result may be obtained at 426. In a particular embodiment, additional communication reports may be requested and analyzed to resolve the inconclusive status.

Returning to 424, if the reporting end terminals are joined to the same multicast group, the method 400 may include, at 428, determining whether any end terminal after the split between the reporting end terminals was subscribed to the multicast group that did not experience the communication anomaly. For example, the method may include requesting communication reports from a plurality of additional end terminals after the split between the reporting end terminals. The received communication reports may be analyzed to determine whether any of the additional end terminals were joined to the same multicast group and did not experience the anomaly. If any end terminal after the split was joined to the same multicast group and did not experience the anomaly, a conclusion may be reach, at 432, that the communication anomaly was probably caused by duplicate problems in the communication paths after the split to the reporting end terminals. If each end terminal after the split joined to the same multicast group experienced the anomaly, a conclusion may be reached, at 430, that the anomaly was probably caused by a problem before the split. Additional communication reports may be requested from end terminals served by devices before the split to determine the probably cause of the communication anomaly.

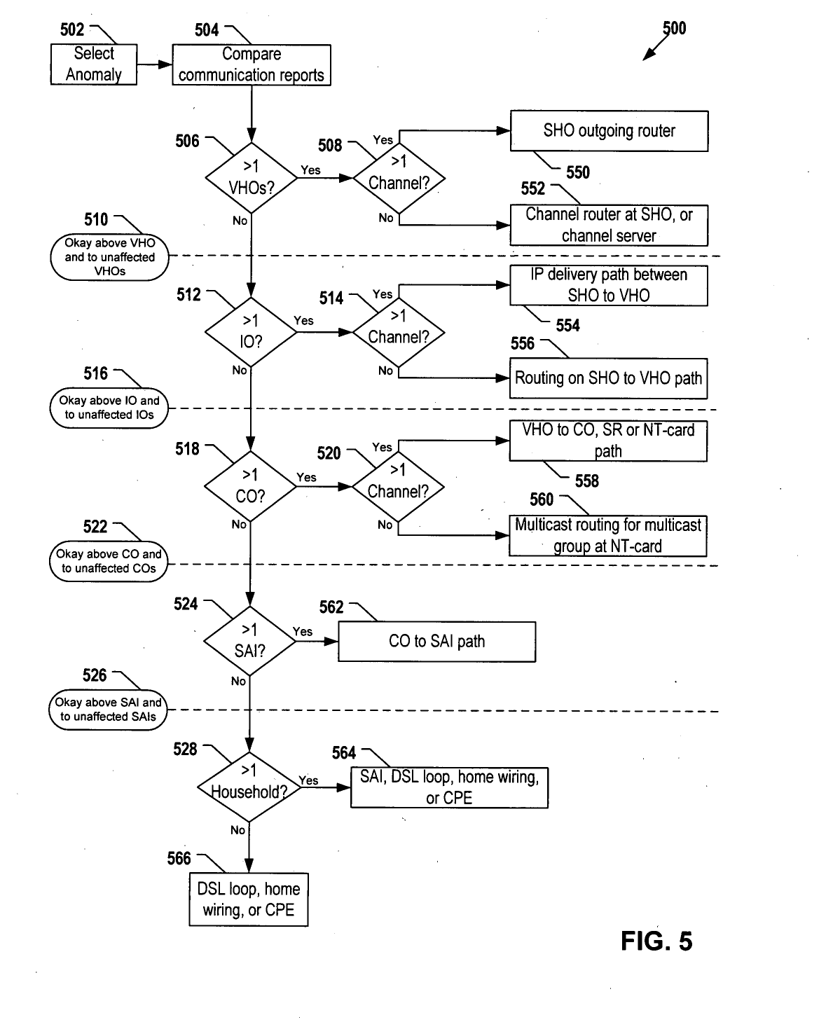

FIG. 5 is a flow chart illustrating a third particular embodiment of a method of network error analysis, generally designated 500. The method 500 includes selecting a communication anomaly, at 502. The method also includes, at 504, comparing a plurality of communication reports received from end terminals of the multicast network. The method 500 also includes, at 506, determining whether the selected anomaly occurred at end terminals associated with more than one video hub office (VHO). If the selected anomaly occurred at end terminals associated with more than one VHO, the method 500 includes, at 508, determining whether the communication anomaly was experienced at end terminals on more than one channel. If the communication anomaly occurred on more than one channel, a conclusion may be reached, at 550, that a super hub office (SHO) outgoing router is the likely cause of the communication anomaly. If the communication anomaly did not occur on more than one channel, a conclusion may be reached, at 552, that a channel router at the SHO or a channel server is the probable cause of the communication anomaly.

If the method 500 determines, at 506, that the communication anomaly occurred at only one VHO, a conclusion may be reached, at 510, that communications to each unaffected VHO are normal. That is, that communications to the unaffected VHOs, e.g., between the SHO and these VHOs, are functioning properly.

The method 500 may also include, at 512, determining whether the communication anomaly occurred at end terminals associated with more than one IO. If the communication anomaly affected more than one IO, the method 500 may include, at 514, determining whether the communication anomaly occurred on more than one channel. If the communication anomaly occurred on more than one channel, a conclusion may be reached, at 554, that an Internet Protocol (IP) delivery path between the SHO and the affected VHO may have caused the communication anomaly. If the communication anomaly occurred on only one channel, a conclusion may be reached, at 556, that the communication anomaly was probably caused by routing on the SHO to VHO communication path.

Returning to 512, if the communication anomaly affected only one IO, a conclusion may be reached, at 516, that communications are normal above the affected IO and to the unaffected IOs. That is, that network devices at the IO and above in the communications path are functioning properly.

The method 500 may also include, at 518, determining whether the communication anomaly occurred at end terminals associated with more than one CO. If the communications anomaly occurred at end terminals associated with more than one CO, the method 500 may include, at 520, determining whether the communication anomaly occurred on more than one channel. If the communication anomaly occurred on more than one channel, a conclusion may be reached, at 558, that the VHO to CO, SR or network termination (NT) card path are the probable cause of the communication anomaly. If the communication anomaly occurred on only one channel, a conclusion may be reached, at 560, that multicast routing for the multicast group associated the channel at the NT card is the probable cause of the communication anomaly.

Returning to 518, if the communication anomaly occurred only at end terminals associated with a single CO, a conclusion may be reached, at 522, that communications above the affected CO and to the unaffected COs are normal. That is, that the network devices in the communication path to the IO that serves the affected CO are functioning.

The method 500 may also include, at 524, determining whether the communication error was experienced at end terminals associated with more than one SAI. If the communication anomaly was experienced at end terminals associated with more than one SAI, a conclusion may be reached, at 562, that the CO to SAI path is the probable cause of the communication anomaly. Returning to 524, if the communication anomaly occurred only at end terminals associated with a single SAI, a conclusion may be reached, at 526, that communications above the affected SAI and to the unaffected SAIs are normal. That is, that the network devices in the communication path to the CO that serves the affected SAI are functioning.

The method 500 may also include, at 528, determining whether the communication anomaly occurred at more than one household. If the communication anomaly occurred at more than one household, a conclusion may be reached, at 564, that the communication anomaly was probably caused by affected SAI, communication medium between the CO and the affected SAI, the communication medium between the SAI and the households (e.g., a DSL loop to the households), the home wiring at the households or the customer premises equipment at the households. If the communication anomaly occurred at only one household, a conclusion may be reached, at 566, that the communication anomaly was probably cause by the communication medium between the SAI and the affected household (e.g., DSL loops to the household), the home wiring at the affected household, or the customer premises equipment at the affected household.

In conjunction with the configuration of structure described herein, the systems and methods disclosed provide network error analysis. In a particular embodiment, a plurality of communication reports from end terminals of a multicast network may be received at a troubleshooting device. The communication reports may identify at least one communication anomaly that occurred at an end terminal. The troubleshooting device may determine a source of at least one communication anomaly based on received communication reports and multicast network topology data.

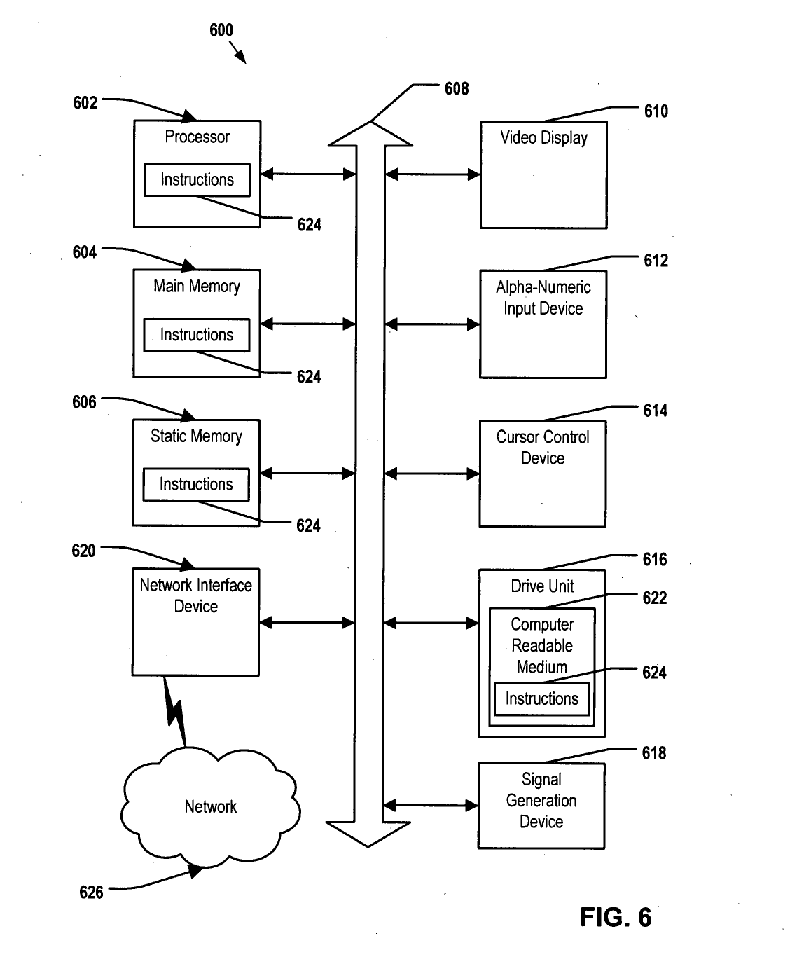

Referring to FIG. 6, an illustrative embodiment of a general computer system is shown and is designated 600. The computer system 600 can include a set of instructions that can be executed to cause the computer system 600 to perform any one or more of the methods or computer based functions disclosed herein. The computer system 600 may operate as a standalone device or may be connected, e.g., using a network, to other computer systems or peripheral devices. In an illustrative embodiment, the computer system 500 may include any one or more of the troubleshooting devices, end terminals, customer premises equipment devices, service area interfaces, Ethernet service switches, service routers, display devices or other network devices depicted in FIGS. 1, 2, and 3.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specifications to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. Moreover, the computer system 600 can include a main memory 604 and a static memory 606, that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, and a cursor control device 614, such as a mouse. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of network error analysis, the method comprising:
receiving a first communication report from a first end terminal of a multicast network, wherein the first communication report identifies a communication anomaly that occurred at the first end terminal and first operational history data regarding the first end terminal;
receiving a second communication report from a second end terminal of the multicast network, wherein the second communication report identifies second operational history data regarding the second end terminal; and
determining a potential cause of the communication anomaly based at least partially on the first operational history data, the second operational history data, and topology data related to the multicast network.

2. The method of claim 1, wherein the first operational history data includes information related to a multicast group to which the first end terminal was joined at a time that the communication anomaly occurred.

3. The method of claim 2, wherein the second operational history data includes information related to a multicast group to which the second end terminal was joined at the time that the communication anomaly occurred.

4. The method of claim 1, wherein the topology data indicates a multicast routing tree.

5. The method of claim 1, wherein the second communication report indicates that the communication anomaly did not occur at the second end terminal, and wherein determining the potential cause of the first communication anomaly comprises identifying at least one network device as a potential cause of the communication anomaly, wherein the at least one network device communicates via the multicast network to the first end terminal, and wherein the at least one network device does not communicate via the multicast network to the second end terminal.

6. The method of claim 5, further comprising determining whether the communication anomaly occurred at the second end terminal.

7. The method of claim 1, wherein, when the second communication report indicates that the communication anomaly occurred at the second end terminal, the method further comprises:
identifying a third end terminal, wherein the communication anomaly did not occur at the third end terminal;
receiving a third communication report from the third end terminal, wherein the third communication report includes third operational history regarding the third terminal; and
determining a potential cause of the communication anomaly based at least partially on the first operational history data, the second operational history data, the third operational history data, and the topology data related to the multicast network.

8. The method of claim 1, wherein, when the second communication report indicates that the communication anomaly did not occur at the second end terminal and that the second end terminal was joined to a second multicast group that is different than the multicast group to which the first end terminal was joined when the communication anomaly occurred, the method further comprises:
receiving a third communication report from a third end terminal, wherein the communication anomaly did not occur at the third end terminal and wherein third operational history data in the third communication report indicates that the third end terminal was joined to the multicast group to which the first end terminal was joined when the communication anomaly occurred at the first end terminal; and
determining a potential cause of the communication anomaly based at least partially on the first operational history data, the second operational history data, the third operational history data, and the topology data regarding the multicast network.

9. The method of claim 1, wherein determining a potential cause of the first communication anomaly comprises identifying an end terminal at which the communication anomaly did not occur.

10. The method of claim 1, wherein the topology data comprises geographic area data associated with the first end terminal and the second end terminal.

11. The method of claim 1, wherein the communication anomaly comprises at least one data packet expected at the first end terminal that was not received, and wherein the first communication report identifies the at least one data packet.

12. The method of claim 1, further comprising querying the second end terminal for the second communication report after receiving the first communication report.

13. The method of claim 12, further comprising selecting the second end terminal based on historical data.

14. The method of claim 12, further comprising selecting the second end terminal based on the topology data.

15. The method of claim 1, further comprising generating a report identifying a potential cause of a set of related anomalies.

16. The method of claim 1, further comprising identifying a network device responsible for the communication anomaly.

17. The method of claim 1, wherein the multicast network comprises an Internet Protocol Television (IPTV) network.

18. A system comprising:
an input to receive communication reports from a plurality of end terminals of a multicast network;
a memory comprising multicast network topology data; and
logic to determine a source of at least one communication anomaly based on the received communication reports and the multicast network topology data.

19. The system of claim 18, wherein the multicast network topology data identifies at least one connection between two or more network devices of the multicast network.

20. The system of claim 18, wherein the multicast network topology data identifies at least one connection between at least one device of the multicast network and at least one of the end terminals.

21. The system of claim 20, wherein the at least one device of the multicast network comprises a device at a video hub office.

22. The system of claim 20, wherein the at least one device of the multicast network comprises a device at a super headend office.

23. The system of claim 20, wherein the at least one device of the multicast network comprises a service router.

24. The system of claim 20, wherein the at least one device of the multicast network comprises an Ethernet service switch.

25. The system of claim 20, wherein the at least one device of the multicast network comprises a service area interface.

26. A computer readable medium comprising computer readable instructions, wherein the computer readable instructions are executable by a computer to perform a method comprising:
receiving a plurality of communication reports from end terminals of a multicast network; and
determining a potential cause of at least one communication anomaly based at least partially on one or more of the plurality of communication reports and network topology information.

27. The computer readable medium of claim 26, wherein the computer readable instructions are further executable to query at least one end terminal for a communication report based at least partially on one or more of the plurality of communication reports.

28. The computer readable medium of claim 26, wherein the computer readable instructions are further executable to select an end terminal to query based on historical error data.

29. The computer readable medium of claim 28, wherein the computer readable instructions are further executable to select an end terminal to query based on subscriber historical data.

30. The computer readable medium of claim 29, wherein the computer readable instructions are further executable to select an end terminal to query based on the network topology information.
